(19) United States
(12) Patent Application Publication
(10) Pub. No.: US 2012/0009311 A1
(43) Pub. Date: Jan. 12, 2012

(54) PREPARED FOOD PRODUCT, METHOD OF PREPARATION AND BAKING APPARATUS FOR SAID PREPARED FOOD PRODUCT

(76) Inventors: JEFFREY STUART LINDSAY, Courtenay (CA); Ann Currylindsay, Courtenay (CA)

(21) Appl. No.: 12/834,004

(22) Filed: Jul. 11, 2010

(51) Int. Cl. A21D 13/00; B21J 13/00

(52) U.S. Cl. 426/283; 72/404

(57) ABSTRACT

A method of preparing a food product comprising the steps of obtaining an amount of suitable baking dough; placing the dough on a flat surface and shaping it into a rectangle; placing a suitable amount of flavoured sauce on the top surface of the dough; preparing a food skewer and placing it on the sauce; placing grated cheese on top of the food skewer; folding the dough rectangle partially over the food skewer to form a folded assembled food product. The product can then be baked in an novel baking pan comprising three baking chambers or the product can be frozen for future consumption.

### CROSS-REFERENCE TO RELATED APPLICATIONS

Not applicable.

### STATEMENT REGARDING FEDERAL SPONSORSHIP

Not Applicable.

### BACKGROUND

1. Field of the Invention

This invention relates to the field of food products and methods for their production and in particular a prepared food product, method of preparation and baking apparatus for preparing said food product.

2. Description of the Prior Art

The traditional disc shaped pizza has been a staple in the home and for restaurant industry for many decades. There are many examples of this type of food and methods of preparation.

For example U.S. Pat. No. 5,256,432 issued to McDonald et al. discloses A Method of Making a Pizza with a Pizza Toppings Disc. The method comprises a standard pizza pan with a first layer of dough covered in pieces of vegetable and meat. This layer is further covered with a second layer of dough.

In another example, U.S. Pat. No. 5,023,096 entitled Food Product and Method for Making the Same issued to Plochman discloses a combination of popcorn and cheese which can be prepared in the form of a pizza.

Yet another example is U.S. Pat. No. 4,367,243 entitled Method for Cooking Pizza issued to Brummette et al. This patent describes a method for reducing the cooking time of a pizza.

Within the food industry, and particularly the frozen food and restaurant industries there is always room for an innovative food product which will catch the imagination of both industry members and the consuming public. There is a continued need for a food product that can be easily assembled and cooked at home as well as a restaurant setting.

### SUMMARY OF THE INVENTION

In accordance with the present invention there is provided a method of preparing a food product comprising the following steps:
a. obtaining an amount of suitable baking dough;
b. placing the amount of suitable baking dough on a flat surface;
c. shaping the amount of suitable baking dough into a dough rectangle having a length, a width, a thickness, a left side, a right side, a long axis and a top surface;
d. placing a suitable amount of flavoured sauce on the top surface of the dough rectangle to substantially cover the top surface;
e. preparing a food skewer having a long axis;
f. placing the food skewer on the suitable amount of flavoured sauce so that the food skewer long axis is co-axial with the dough rectangle long axis;
g. placing a predetermined amount of grated cheese product on top of the food skewer to form an assembled food product;
h. folding the left side and the right side of the dough rectangle so that the left side and right side of the dough rectangle are in contact with the food skewer to form a folded assembled food product;
i. placing the folded assembled food product into a baking apparatus; and,
j. baking the folded assembled food product within the baking apparatus for a first suitable amount of time at a first suitable temperature until a completely baked state is obtained.

The step of shaping the amount of suitable baking dough into a dough rectangle includes the step of dimensioning the dough rectangle so that the dough rectangle length is approximately three times the dough rectangle width.

The step of preparing said food skewer comprises the following steps:
a. obtaining a wood skewer having a length slightly longer than the dough rectangle length; and,
b. placing, alternatively, pieces of vegetable and pieces of meat onto the skewer until it is substantially covered.

In another embodiment of the invention, after the food skewer is prepared, there is a further step of freezing the prepared food skewer the result being that a plurality of prepared food skewers can be stored in a frozen state for subsequent use. This is particularly advantageous for domestic and industrial restaurant settings.

In yet another embodiment of the invention, after folded food product has been made there is a further step of adding strips of a second suitable cheese product to the top of the folded assembled food product.

In still another embodiment of the invention, after the folded assembled food product is prepared there is an additional step of freezing it, the result being that a plurality of folded assembled food product can be stored in frozen for subsequent use.

In another embodiment of the invention after the folded food product is placed within a baking apparatus there is a further step of placing the baking apparatus with the assembled food product contained therein in a freezer, the result being that a combined baking apparatus and assembled food product can be stored for subsequent use and conveniently thawed as a unit.

In yet another embodiment of the invention, after the folded food product has been placed within the baking apparatus the folded food product is baked apparatus for a suitable amount of time at a suitable temperature until completely baked.

In yet another embodiment of the invention, after the folded food product has been placed within the baking apparatus the folded food product is baked for a second suitable amount of time at a second suitable temperature until only partially baked. In this way, the partially baked food product can be frozen and then, at another time, completely baked in a shorter amount of time.

In another embodiment of the invention there is a method of preparing a second type of food product comprising the following steps:
a. obtaining an first amount of suitable baking dough;
b. placing the first amount of suitable baking dough on a flat surface;
c. shaping the first amount of suitable baking dough into a first dough rectangle having a length, a width, a thickness, a left side, a right side, a first end, a second end, a long axis and a top surface;
d. placing a suitable amount of flavoured sauce on said top surface of the first dough rectangle to substantially cover the top surface;
e. preparing a food skewer having a first end, a second end and a long axis;
f. placing the food skewer on the suitable amount of flavoured sauce so that said food skewer long axis is co-axial with said first dough rectangle long axis;
g. placing a predetermined amount of grated cheese product on top of the food skewer to form an assembled food product;
h. folding the left side and the right side of the first dough rectangle so that the left side and right side of the first dough rectangle are in contact with the food skewer;
i. folding the first dough rectangle first end over the food skewer first end and folding the first dough rectangle second end over the food skewer second end so that the food skewer first and second ends are covered by the first dough rectangle and so that the assembled food product has an open top surface;
j. obtaining an second amount of suitable baking dough;
k. placing the second amount of suitable baking dough on a flat surface;
l. shaping the second amount of suitable baking dough into a second dough rectangle;
m. placing the second dough rectangle onto the open top surface of the assembled food product thereby forming a closed food product;
n. placing the closed food product into a baking apparatus; and,
o. baking the closed food product within said baking apparatus for a first suitable amount of time at a first suitable temperature until a completely baked state is obtained.

The present invention also includes a method for manufacturing a baking apparatus for cooking a food products described above, comprising the following steps:
a. obtaining a first rectangular sheet of a suitable metal having a left side, a right side, a length, a width, a front, a back and a long axis;
b. press forming the first rectangular sheet so that there is within the first rectangular sheet, along the long axis from said left side to said right side, the following features:
   i. a first flat surface followed by;
   ii. a first generally perpendicular surface depending from the first flat surface followed by;
   iii. a second flat surface followed by;
   iv. a second generally perpendicular surface depending from the second flat surface followed by;
   v. a plurality of parallel and adjacent arcuate baking chambers separated by ridges followed by;
   vi. a third generally perpendicular surface followed by;
   vii. a third flat surface followed by;
   viii. a fourth generally perpendicular surface followed by;
   ix. a fourth flat surface.

In each of the baking chambers there is pressed a plurality of holes.

There is also a second metallic member generally equal in length to the length of the first rectangular sheet. The second metallic member is formed with a flat surface and a perpendicular surface. Then it is fixing between said left and right sides of the back side of the first rectangular sheet, so that each of the plurality of baking chambers has an open front end and an open rear end.

In one embodiment of the baking apparatus there is fixed a first handle to the first flat surface and the step of fixing a second handle to the fourth flat surface.

### BRIEF DESCRIPTION OF THE DRAWINGS

FIG. 1 is a top view of one embodiment of a prepared food product by the method of the invention.

FIGS. 2a to 2f are figures illustrating the assembly of the prepared food product of FIG. 1.

FIG. 3 is a view of a second embodiment of a prepared food product by the method of the invention.

FIGS. 4a to 4f are figures illustrating the assembly of the prepared food product of FIG. 3.

FIG. 5 is a top view of a first embodiment of the baking apparatus of the invention.

FIG. 6 is a bottom view of the baking apparatus of FIG. 5.

FIG. 7 is a side view of the baking apparatus of FIG. 5.

FIG. 8 is a front perspective view of a second embodiment of the baking apparatus of the invention.

FIG. 9 is a side perspective view of the baking apparatus of FIG. 8

### DETAILED DESCRIPTION OF THE PREFERRED EMBODIMENTS

### First Embodiment

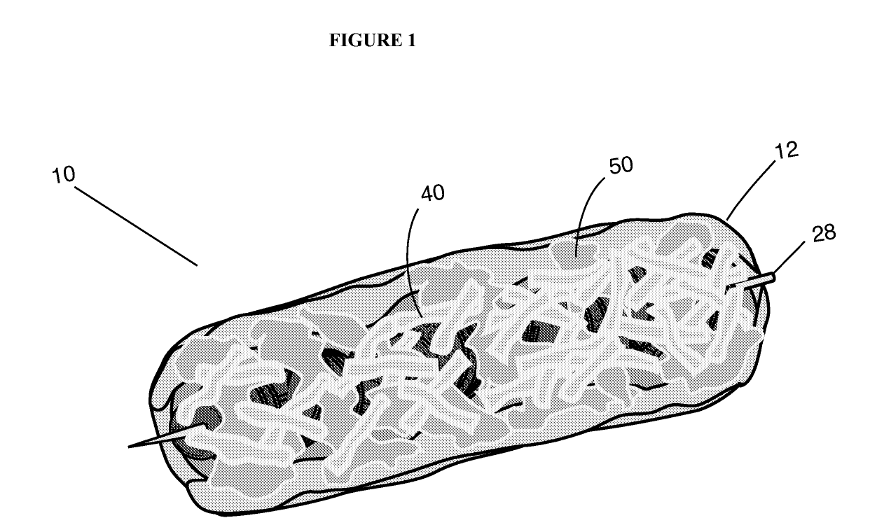

Referring to FIG. 1 there is shown a top view of a first embodiment of a prepared food product 10 of the present invention. The food product 10 is shown in its assembled and baked state ready for consumption. The food product 10 is assembled as described below.

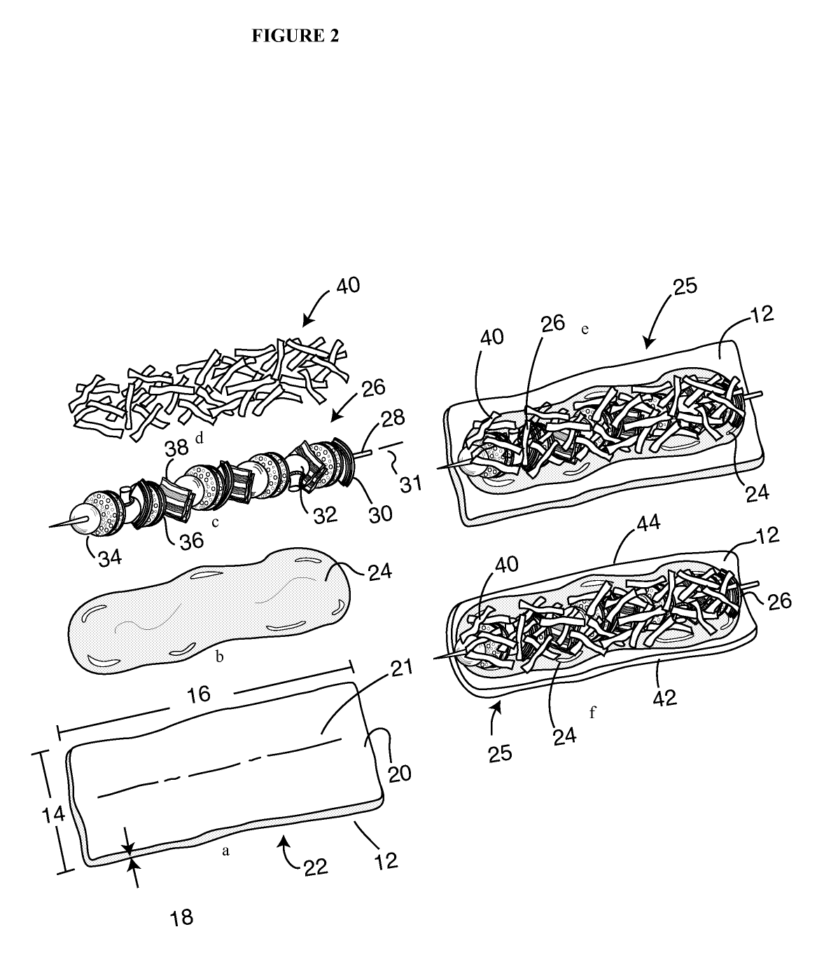

Referring to FIGS. 2a to 2f there is shown an assembly diagram of the various constituents of the assembled food product 10 as illustrated in FIG. 1.

Referring to FIG. 2a, there is shown a first layer of dough 12. The dough is preferably a pizza dough but it could also be bread dough or another type of dough suitable for baking. The layer of dough 12 is laid upon a flat surface (not shown). The piece of dough is rectangular in shape and has a width 14, a length 16 and a thickness 18. The length 16 of the rectangular piece of dough 12 is approximately three times its width 14. In one embodiment of the invention the rectangle piece of dough 12 is approximately 10 inches long by 3 inches wide by ¼ inch thick. These dimensions can vary. The dough rectangle 12 has a top surface 20 and a bottom surface 22. The dough rectangle also has a long axis 21.

Referring now to FIG. 2b, there is illustrated a layer of a suitable sauce 24 which is placed upon the top surface 20 of the dough rectangle 12. The sauce 24 may have any suitable flavour and constituency. For example the sauce may comprise a cheese sauce, a meat sauce or a sauce having a combination of spices. The sauce can be made to suit any taste.

Referring now to 2c there is shown pieces of vegetable and meat 26 skewered onto a wooden skewer 28. The pieces of vegetable may comprises onion 30, mushroom 32 and tomato 34.

Between the vegetable pieces are placed meat products such as sausage 36 and bacon 38. In other embodiments, the food skewered onto the skewer 28 can be all vegetable to suit a vegetarian diet, or fish or poultry. These food skewers 26 are easily prepared and can be frozen in both a domestic and industrial setting to facilitate the easy assembly of the final food product 10. For assembly if the final food product 10, the food skewers 26 can be removed from a freezer and left to thaw. Then, once thawed, they can be integrated into the food product. The next step is to place the food skewer 26 upon the sauce 24. The food skewer includes a long axis 31.

Referring to FIG. 2d there is represented a layer of a grated cheese product 40. The cheese product can be any suitable cheese product such as mozzarella or cheddar cheese. The cheese product 40 is spread over the top surface of the food skewer 26 as illustrated in FIG. 2e.

Referring now to FIG. 2e, there is shown an assembled food product 25. The assembled food product 25 includes a rectangular base layer of suitable dough 12, a layer of a suitable sauce 24, a food skewer 26 placed onto the sauce, and a layer of grated cheese product 40 over the food skewer 26.

Now referring to FIG. 2f, the next step is to fold the length wise sides 42 and 44 of the dough rectangle 12 upwards as shown. The result is that the food skewer 26 is partially enclosed by the dough and in contact with the sauce 24. The food product 25 is now ready to be placed in the baking apparatus of the invention which is more fully described below.

The assembled food product 25 can be frozen in the state shown in FIG. 2e, that is, with the dough layer 12 flat. The frozen product 25 can then be removed from the freezer, thawed, and placed in the baking apparatus of the invention for baking.

In another embodiment, the assembled product 25 can be placed in the baking apparatus of the invention and then frozen so that it takes the form of the baking apparatus. Then the frozen product can be taken from the product and placed directly into the baking apparatus without waiting for it to thaw prior to folding it.

Referring back to FIG. 1, there is illustrated an assembled and baked food product 10. The dough rectangle 12 has been folded to take the form of the baking apparatus and is baked for a suitable period of time at a suitable temperature until the dough is a brown colour as illustrated by the shaded colour of the dough. The cheese product 40 has melted over the top of the cooked food product. The skewer 28 remains in place and is made from a suitable wood product that can withstand the baking temperatures necessary to bake the food product. Alternatively additional slices of cheese 50 maybe placed across the top of the food product 10. The additional cheese product 50 maybe of a different type of cheese than cheese product 40. For example, cheese product may be mozzarella and cheese product 50 may be cheddar.

The assembled food product 10 illustrated in FIG. 1 may also be partially cooked and then frozen so that it is baked in a shorter time period. This is advantageous in both a domestic setting and industrial restaurant setting.

### Second Embodiment

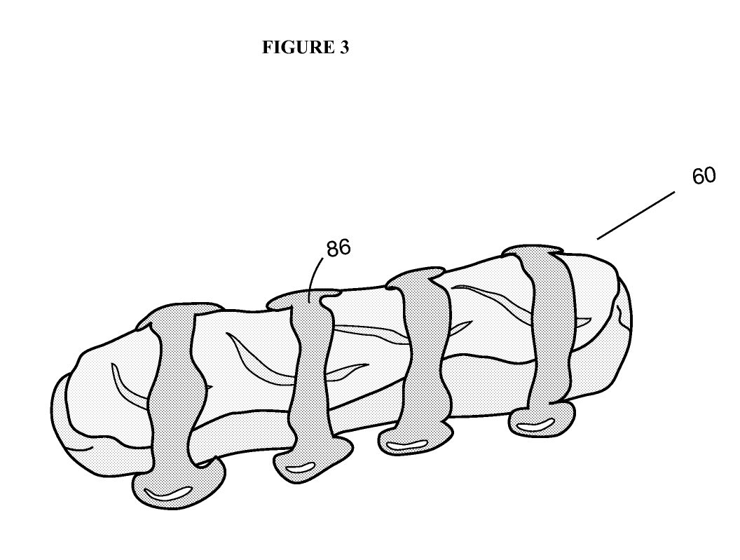

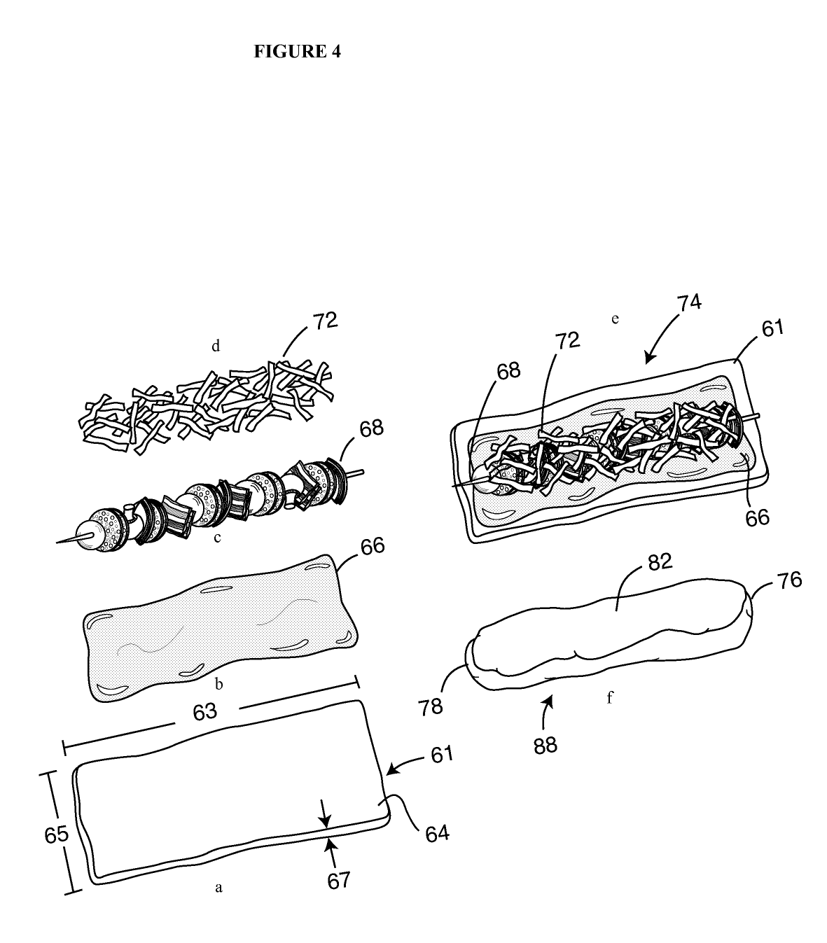

Referring to FIG. 3 there is illustrated a second embodiment of a food product 60. Referring to FIGS. 4a to 4f there are illustrated the various steps to the assembly of the food product 60.

Referring to FIG. 4a there is shown a second rectangle of dough 61 having a top surface 64. The length 63, width 65 and thickness 67 of the dough are similar to those of rectangle 12 in FIG. 2a.

Referring to FIG. 4b a suitable layer of sauce product 66 is placed on the top surface 64 of the dough rectangle 61. The sauce can be of any suitable taste and constituency.

Referring to FIG. 4c, the a food skewer 68 is placed upon the layer of sauce 66. The food skewer 68 is similar in make-up to food skewer 26.

Referring to FIG. 4d a suitable cheese product 72 is then placed over the top of the food skewer 68.

Referring to FIG. 4e, the partially assembled second embodiment of the food product 74 is illustrated comprising the base layer of dough 61, the layer of sauce 66, the food skewer 68 and the cheese product 72.

Referring now to FIG. 4f, in this embodiment there is an additional step of folding the ends 76 and 78 of the dough rectangle over the ends of the food skewer 68 so that it is enclosed. Next, a second layer of dough 82 is placed upon the food product 74 to enclose the entirety of the food skewer 68. In this assembled state the uncooked food product 84 maybe frozen in bulk for domestic and industrial restaurant use.

Referring back to FIG. 3f, the uncooked frozen product 88 can be removed from a freezer and then placed in the baking apparatus of the invention which is described below. In the embodiment shown in FIG. 3, a further suitable cheese product 86 maybe placed over the food product 60 prior to baking. Once the food product is baked the cheese product 84 will melt and the baked product will appear similar to that illustrated in FIG. 3.

The baked product in either embodiment can be served with a variety of foods such as spaghetti and lasagne.

The Baking Apparatus

The baking apparatus of the invention has been designed to bake the completed food products shown in FIG. 2f and FIG. 4f.

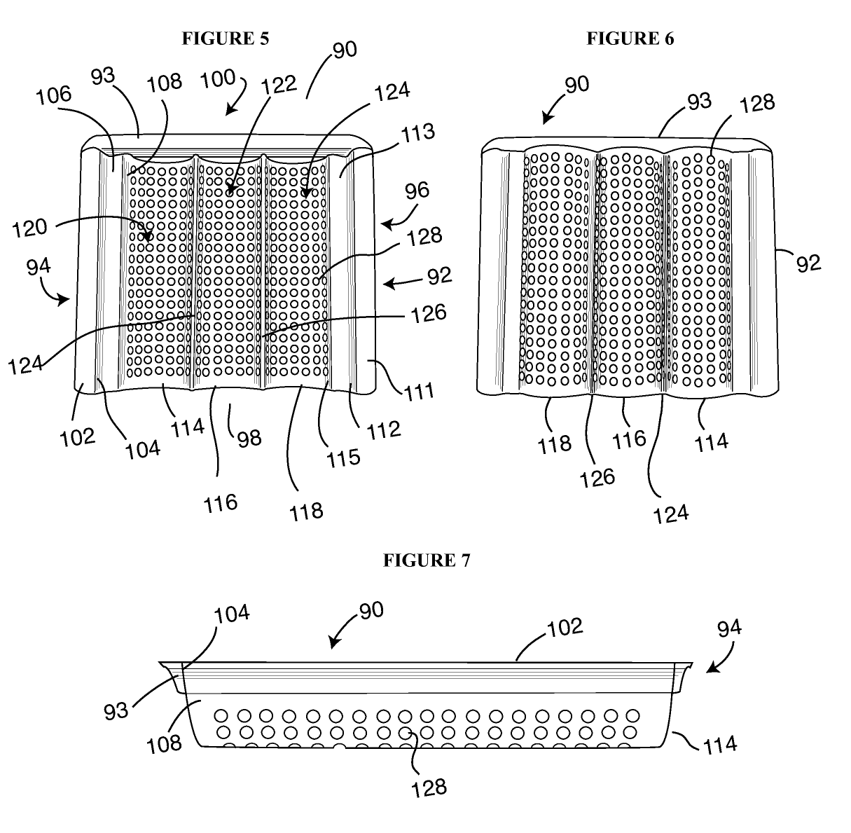

Referring now to FIGS. 5, 6 and 7 there is shown a top view, bottom view and left side view of a preferred embodiment of the baking apparatus 90. The apparatus 90 comprises a first piece 92 that is pressed from a single rectangular piece of suitable metal such as aluminum. The fact that the piece 92 is pressed from a single piece of rectangular metal means that manufacturing costs will be very low. A second piece of pressed metal 93 is fixed to the back end 100 of member 92. Member 92 is pressed into the illustrated shape and comprises a left side 94 and right side 96 and a front end 98 and a back end 100. Member 92 further comprises on the left side 94 a top flat surface 102 a generally perpendicular surface 104 depending downwards from the top surface 102 and a second flat surface 106 extending horizontally from the bottom of perpendicular surface 104. A second generally perpendicular surface 108 depends downward from second flat surface 106 until it meets the apertured baking chamber 114.

On the right side 96 of member 92 there is pressed a mirror image of the features of the left side 94. The right side 96 comprises a first top surface 111, a generally perpendicular surface 112 depending down from the first top surface 111, a second flat surface 113 and a second generally perpendicular surface 115 depending down from second flat surface 113 until it meets the apertured baking chamber 118.

In this embodiment of the baking apparatus three baking chambers 114, 116, and 118 are illustrated. A previously described, the assembled food product of the first and second embodiments can be placed into the baking chambers for freezing so that their frozen shapes will agree with the shape of the baking chambers. The assembled food products can also be placed uncooked into the baking chambers for baking.

The baking chambers 114, 116 and 118 comprise a semi-circular baking surface 120, 122 and 124. The baking chambers are adjacent and parallel to each other and are pressed from a single rectangular piece of metal 92. The result is that the adjacent and parallel chambers are integral at their ends forming mid ridges 124 and 126. Each of the baking chambers 114, 116 and 118 comprise a plurality of perforations 128 across their entire surface. These perforations permit an even heat distribution along the bottom surfaces of the food product placed in the baking chambers. While the embodiment shown in FIGS. 5, 6 and 7 comprise three baking chambers more or fewer chambers can be used. In the embodiment shown in FIG. 5 three baking chambers may be suitable for a domestic setting however in an industrial setting the baking apparatus may comprise more than three baking chambers.

Referring now to FIG. 6 there is shown a bottom view of the baking apparatus 90 illustrated in FIG. 5. Member 92 is shown comprising the three arcuate baking chambers 114, 116 and 118 which in the bottom view appear as having vaulted or barrel shapes. The apertures 128 are illustrated and show that the almost entirety of the food product will have its bottom surface exposed to heat and so evenly cooked by an even heat distribution.

Second piece 93 is shown in FIG. 5 and FIG. 6. It comprises a simple pressed piece that is fixed to piece 92 at its back end 100 by means such as welding.

Referring to FIG. 7 there is shown a left side 94 view of the baking apparatus 90 showing the near perpendicular surface 104 and the side of baking chamber 114 having a plurality of perforations 128 distributed evenly across its surface area.

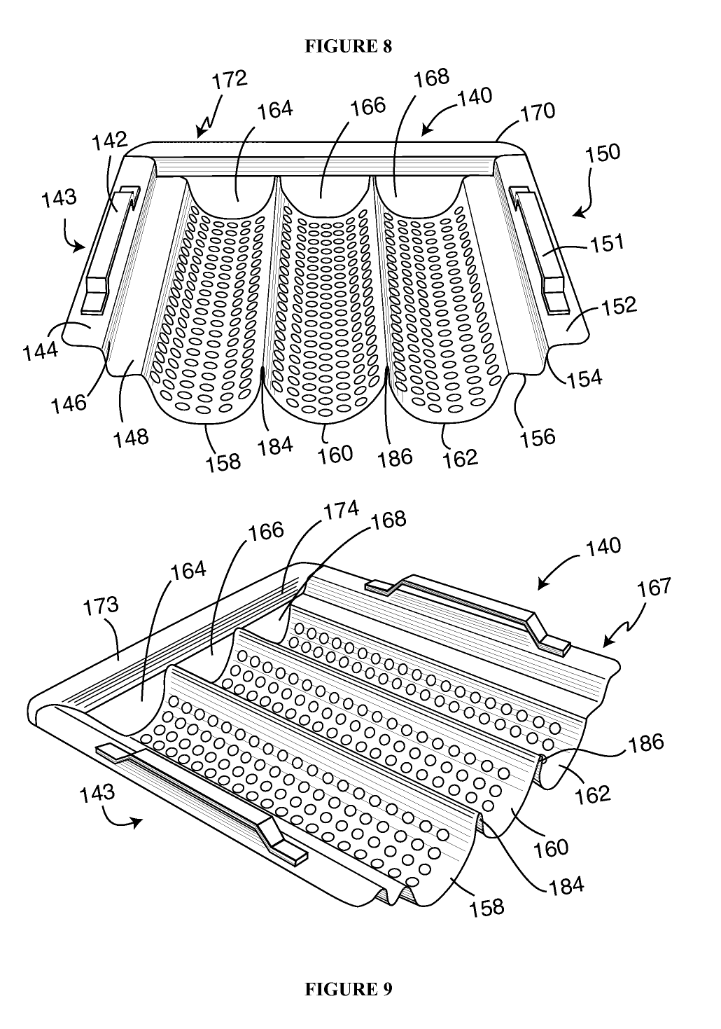

Referring now to FIG. 8 there is illustrated a second embodiment of the baking apparatus 140. In this second embodiment a first handle 142 is fixed to the left side 143 top surface 144. The top surface 144 bends over and downward to form a perpendicular surface 146. A second flat horizontal surface 148 is pressed into the apparatus. On the right side 150 a second handle 151 is fixed to top surface 152. Top surface 152 is pressed downwards to form near perpendicular surface 154 and then further pressed to form a second flat horizontal surface 156. Three baking chambers 158, 160 and 162 are showing having open front ends and open rear ends 164, 166 and 168. A second piece 170 is fixed at the back end 172 of the baking apparatus 170 to stiffen the baking apparatus.

Referring to FIG. 9 the second embodiment of the baking apparatus 140 is illustrated from a left side 143 perspective view. Second piece 170 is illustrated with top surface 173 and a curved surface 174 depending downwards from top surface 173. The ends 164, 166 and 168 of the baking chambers 158, 160 and 162 are open. FIGS. 8 and 9 illustrate how the baking apparatus is pressed from a single sheet of rectangular metal 167. The three baking chambers 158, 160 and 162 are pressed into the sheet of metal 167 forming apex 184 and 186 as an integral boundary between the three baking chambers.

Although this specification sets forth a detailed description of numerous different embodiments, it should be understood that the legal scope of the description is defined by the words of the claims set forth herein. The detailed description is to be construed as exemplary only and does not describe every embodiment.

What is claimed is:

1. A method of preparing a food product comprising the following steps:
a. obtaining an amount of suitable baking dough;
b. placing said amount of suitable baking dough on a flat surface;
c. shaping the amount of suitable baking dough into a dough rectangle having a length, a width, a thickness, a left side, a right side, a long axis and a top surface;
d. placing a suitable amount of flavoured sauce on said top surface of the dough rectangle to substantially cover the top surface;
e. preparing a food skewer having a long axis;
f. placing said food skewer on the suitable amount of flavoured sauce so that said food skewer long axis is co-axial with said dough rectangle long axis;
g. placing a predetermined amount of grated cheese product on top of the food skewer to form an assembled food product;
h. folding said left side and said right side of the dough rectangle so that the left side and right side of the dough rectangle are in contact with the food skewer to form a folded assembled food product;
i. placing said folded assembled food product into a baking apparatus; and,
j. baking the folded assembled food product within said baking apparatus for a first suitable amount of time at a first suitable temperature until a completely baked state is obtained.

2. The method of claim 1, wherein the step of shaping the amount of suitable baking dough into a dough rectangle includes the step of dimensioning said dough rectangle so that said dough rectangle length is approximately three times said dough rectangle width.

3. The method of claim 1, wherein said step of preparing said food skewer comprises the following steps:
a. obtaining a wood skewer having a length slightly longer than the dough rectangle length; and,
b. placing, alternatively, pieces of vegetable and pieces of meat onto the skewer until it is substantially covered.

4. The method of claim 3, wherein after the step b, a further step of freezing the prepared food skewer is included, the result being that a plurality of prepared food skewers can be stored in a frozen state for subsequent use.

5. The method of claim 1, wherein after step i, a further step of adding strips of a second suitable cheese product to the top of the folded assembled food product.

6. The method of claim 1, wherein after step h, a further step of freezing the folded assembled food product is included, the result being that a plurality of folded assembled food product can be stored in frozen for subsequent use.

7. The method claim 1, wherein after step i, a further step of placing said baking apparatus with the assembled food product contained therein in a freezer is included, the result being that a combined baking apparatus and assembled food product can be stored for subsequent use and conveniently thawed as a unit.

8. The method of claim 1, wherein after step i, there is a step of:
a. baking the folded assembled food product within said baking apparatus for a second suitable amount of time at a second suitable temperature until partially baked; and,
b. freezing said partially baked folded assembled food product for subsequent use, the result being that subsequent baking of the partially baked food product to obtain said completely baked state will be less than said first predetermined period of time.

9. A method of preparing a food product comprising the following steps:
a. obtaining an first amount of suitable baking dough;
b. placing said first amount of suitable baking dough on a flat surface;
c. shaping the first amount of suitable baking dough into a first dough rectangle having a length, a width, a thickness, a left side, a right side, a first end, a second end, a long axis and a top surface;
d. placing a suitable amount of flavoured sauce on said top surface of the first dough rectangle to substantially cover the top surface;
e. preparing a food skewer having a first end, a second end and a long axis;
f. placing said food skewer on the suitable amount of flavoured sauce so that said food skewer long axis is co-axial with said first dough rectangle long axis;
g. placing a predetermined amount of grated cheese product on top of the food skewer to form an assembled food product;
h. folding said left side and said right side of the first dough rectangle so that the left side and right side of the first dough rectangle are in contact with the food skewer;
i. folding said first dough rectangle first end over said food skewer first end and folding said first dough rectangle second end over said food skewer second end so that the food skewer first and second ends are covered by the first dough rectangle and so that said assembled food product has an open top surface;
j. obtaining an second amount of suitable baking dough;
k. placing said second amount of suitable baking dough on a flat surface;
l. shaping the second amount of suitable baking dough into a second dough rectangle;
m. placing said second dough rectangle onto said open top surface of the assembled food product thereby forming a closed food product;
n. placing said closed food product into a baking apparatus; and,
o. baking the closed food product within said baking apparatus for a first suitable amount of time at a first suitable temperature until a completely baked state is obtained.

10. The method of claim 9, wherein after step m, a further step of adding strips of a second suitable cheese product to the top of said closed food product.

11. The method of claim 9, wherein after step m, a further step of freezing the closed food product, the result being that a plurality of closed food product can be stored in frozen for subsequent use.

12. The method claim 9, wherein after step n, a further step of placing said baking apparatus with the closed food product contained therein in a freezer, the result being that a combined baking apparatus and closed food product can be stored for subsequent use and conveniently thawed as a unit.

13. The method of claim 9, wherein after step n, there is a step of:
a. baking the closed food product within said baking apparatus for a second suitable amount of time at a second suitable temperature until partially baked; and,
b. freezing said partially baked closed assembled food product for subsequent use, the result being that subsequent baking of the partially baked food product to obtain said completely baked state will be less than said first predetermined period of time.

14. A method of manufacturing a baking apparatus for cooking a food product comprising the following steps:
a. obtaining a first rectangular sheet of a suitable metal having a left side, a right side, a length, a width, a front, a back and a long axis;
b. press forming said first rectangular sheet so that there is within the first rectangular sheet, along the long axis from said left side to said right side, the following features:
i. a first flat surface followed by;
ii. a first generally perpendicular surface depending from said first flat surface followed by;
iii. a second flat surface followed by;
iv. a second generally perpendicular surface depending from said second flat surface followed by;
v. a plurality of parallel and adjacent arcuate baking chambers separated by ridges followed by;
vi. a third generally perpendicular surface followed by;
vii. a third flat surface followed by;
viii. a fourth generally perpendicular surface followed by;
ix. a fourth flat surface.

15. The method of claim 14, further comprising the step of pressing a plurality of holes into the said plurality of baking chambers.

16. The method of claim 15, further comprising the steps of:
a. obtaining a metallic member having a length generally equal to said length of the first rectangular sheet;
b. pressing into said metallic member a flat surface and a perpendicular surface; and,
c. fixing the metallic member between said left and right sides of said back side of the first rectangular sheet, so that each of the plurality of baking chambers has an open front end and an open rear end.

17. The method of claim 16, further comprising the step of fixing a first handle to the first flat surface and the step of fixing a second handle to the fourth flat surface.
